(19) United States
(12) Patent Application Publication
(10) Pub. No.: US 2026/0034552 A1
(43) Pub. Date: Feb. 5, 2026

(54) A TEMPERATURE CONTROLLED SHOWER HEAD FOR A PROCESSING TOOL

(71) Applicant: Lam Research Corporation, Fremont, CA (US)

(72) Inventors: Christopher Matthew JONES, Woodburn, OR (US); Aaron DURBIN, Portland, OR (US); Aaron Blake MILLER, West Linn, OR (US); Paul C. LEMAIRE, Portland, OR (US); Bryce Isaiah EDMONDSON, Portland, OR (US); Joseph R. ABEL, West Linn, OR (US)

(73) Assignee: Lam Research Corporation, Fremont, CA (US)

(21) Appl. No.: 19/100,043

(22) PCT Filed: Aug. 21, 2023
(86) PCT No.: PCT/US2023/072595

§ 371 Date: Jan. 30, 2025

Related U.S. Application Data
(60) Provisional application No. 63/373,981, filed on Aug. 30, 2022.

(51) Int. Cl. B05B 1/24

(52) U.S. Cl. CPC B05B 1/24

(57) ABSTRACT

An apparatus includes a shower head comprising a disk and a stem coupled with the disk and an adjuster coupled with the stem. The adjuster includes an adapter comprising a heater cartridge; and a fluid line adjacent to the heater cartridge, where the heater cartridge extends from a top surface of the adapter through a first cavity in the adapter and within a second cavity in the stem. The adapter further includes a bellows comprising a flange, where the bellows is coupled with the adapter through the flange.

### CLAIM FOR PRIORITY

This application claims priority to U.S. Provisional Patent Application No. 63/373,981, filed on Aug. 30, 2022, titled “TEMPERATURE CONTROLLED SHOWER HEAD FOR A PROCESSING TOOL,” and which is incorporated by reference in entirety.

### BACKGROUND

Substrate processing for etch and deposition form a backbone of the semiconductor industry. While a variety of processing techniques may be utilized, virtually all processes utilize a shower head to deliver process gases to a substrate awaiting process. Depending on the nature of the process (deposition or etch), the process gas may be heated to enable chemicals to be deposited or to enhance etching. While heating can be important for many processes, maintaining temperature of the process gas for process uniformity and reproducibility is important. As such, methods are being investigated to accomplish effective temperature control.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Also, various physical features may be represented in their simplified “ideal” forms and geometries for clarity of discussion, but it is nevertheless to be understood that practical implementations may only approximate the illustrated ideals. For example, smooth surfaces and square intersections may be drawn in disregard of finite roughness, corner-rounding, and imperfect angular intersections, characteristic of structures formed by nanofabrication techniques. Further, where considered appropriate, reference labels have been repeated among the figures to indicate corresponding or analogous elements.

FIG. 1 is a cross-sectional illustration of a process chamber including a shower head and a substrate support assembly, in accordance with an implementation of the present disclosure.

FIG. 2 is a cross-sectional illustration of an apparatus including a shower head coupled with an adjuster, in accordance with an implementation of the present disclosure.

FIG. 3 is a plan-view illustration of the apparatus in FIG. 2, in accordance with an implementation of the present disclosure.

FIG. 4A is an isometric illustration of the fluid line illustrated in FIG. 2 and in FIG. 3, in accordance with an implementation of the present disclosure.

FIG. 4B is a cross-sectional illustration of the fluid line in FIG. 4A, through a line A-A′, in accordance with an implementation of the present disclosure.

FIG. 5 is a cross-sectional illustration of an apparatus including a shower head coupled with an adjuster, in accordance with an implementation of the present disclosure.

FIG. 6A is an isometric illustration of the fluid line illustrated in FIG. 5, in accordance with an implementation of the present disclosure.

FIG. 6B is a cross-sectional illustration of the fluid line in FIG. 6A, through a line A-A′, in accordance with an implementation of the present disclosure.

FIG. 7 is a cross-sectional illustration of a system, including a shower head and a substrate support assembly, in accordance with an implementation of the present disclosure.

FIG. 8 illustrates a flow diagram of a method to control temperature in a shower head during processing of a substrate, in accordance with an implementation of the present disclosure.

FIG. 9A is a cross-sectional illustration of the system in FIG. 7 during an operating condition where temperature in a shower head increases during processing, in accordance with an implementation of the present disclosure.

FIG. 9B is a cross-sectional illustration of the system in FIG. 7 during an operating condition where temperature in a shower head decreases during processing, in accordance with an implementation of the present disclosure.

### DETAILED DESCRIPTION

An apparatus for diverting heat flow in a process tool is described. In the following description, numerous specific details are set forth, such as structural schemes to provide a thorough understanding of implementations of the present disclosure. It will be apparent to one skilled in the art that implementations of the present disclosure may be practiced without these specific details. In other instances, well-known features, such as radio frequency sources, are described in lesser detail to not unnecessarily obscure implementations of the present disclosure. Furthermore, it is to be understood that the various implementations shown in the Figures are illustrative representations and are not necessarily drawn to scale.

In some instances, in the following description, well-known methods and devices are shown in block diagram form, rather than in detail, to avoid obscuring the present disclosure. Reference throughout this specification to “an implementation” or “one implementation” or “some implementations” means that a particular feature, structure, function, or characteristic described in connection with the implementation is included in at least one implementation of the disclosure. Thus, the appearances of the phrase “in an implementation” or “in one implementation” or “some implementations” in various places throughout this specification are not necessarily referring to the same implementation of the disclosure. Furthermore, the particular features, structures, functions, or characteristics may be combined in any suitable manner in one or more implementations. For example, a first implementation may be combined with a second implementation anywhere the particular features, structures, functions, or characteristics associated with the two implementations are not mutually exclusive.

Here, “coupled” and “connected,” along with their derivatives, may be used herein to describe functional or structural relationships between components. These terms are not intended as synonyms for each other. Rather, in particular implementations, “connected” may be used to indicate that two or more elements are in direct physical, optical, or electrical contact with each other. “Coupled” may be used to indicate that two or more elements are in either direct or indirect (with other intervening elements between them) physical, electrical or in magnetic contact with each other, and/or that the two or more elements co-operate or interact with each other (e.g., as in a cause-and-effect relationship).

Here, “over,” “under,” “between,” and “on” as used herein may generally refer to a relative position of one component or material with respect to other components or materials where such physical relationships are noteworthy. Unless these terms are modified with “direct” or “directly,” one or more intervening components or materials may be present. Similar distinctions are to be made in the context of component assemblies. As used throughout this description, and in the claims, a list of items joined by “at least one of” or “one or more of” can mean any combination of the listed terms.

Here, “adjacent” here may generally refer to a position of a thing being next to (e.g., immediately next to or close to with one or more things between them) or adjoining another thing (e.g., abutting it).

Unless otherwise specified in the explicit context of their use, the terms “substantially equal,” “about equal” and “approximately equal” mean that there is no more than incidental variation between two things so described. In the art, such variation is typically no more than +/−10% of a referred value.

Processing tools are utilized to accomplish a variety of deposition and etch processes in semiconductor device manufacturing. Processing tools can include a process chamber and one or more substrate support assemblies for single wafer processing or multi-wafer processing capabilities for batch processing. A substrate support assembly may include various components such as cooling gas lines, pusher pins, RF lines, heating electrodes, etc. Heating electrodes within the substrate support assembly may be implemented to accelerate or enhance chemical reactivity to facilitate substrate processing. The process chamber may also be heated to provide uniform processing conditions for multiple wafer processing.

Processing tools further include a gas delivery system and a shower head coupled with the gas delivery system. In at least one implementation, a process gas may be delivered at a desired processing temperature to a substrate placed on the substrate support assembly through the shower head. In at least one implementation, the desired processing temperature may be greater than room temperature. In some such implementations, the shower head may include a conductive material. In at least one implementation, conductive material may be heated to maintain the desired process temperature of the process gas. However, the substrate support assembly may also be heated. In at least one implementation, the substrate support assembly may be heated to a temperature that is greater than the temperature of the process gas or the shower head. Heat may radiate away from the substrate support assembly during processing. The heat radiated from the substrate support assembly as well as from the chamber can influence temperature at the shower head. For example, absorption of heat radiated from the substrate support assembly can raise the temperature of the shower head. A change in temperature (for example, an increase in temperature) at the shower head can change the properties of the gas delivered. Additionally, the changes in temperature of the shower head may be non-uniform over a surface area of the shower head. Regions of non-uniform temperature in the vicinity of exit holes in the shower head can create non-uniform processing conditions over a substrate. Furthermore, changes in temperature at the shower head can occur during processing or during the time period between processing two subsequent substrates.

To minimize processing temperature variations, it may be desirable to implement a temperature control system integrated locally within the shower head. In at least one implementation, an apparatus for controlling temperature includes an adjuster coupled with the shower head. The adjuster is a structure that includes a thermally conductive material. In at least one implementation, the adjuster further includes one or more heater cartridges as well as one or more fluid lines. In at least one implementation, heater cartridges may be inserted in a respective cavity within the adjuster and within the shower head and be in thermal contact with the adjuster as well as the shower head. In at least one implementation, one or more fluid lines may at least partially encircle the one or more heater cartridges and may flow water or other chemicals to reduce the ambient temperature of the adjuster and shower head. In at least one implementation, fluid lines may be formed by grooves within the body of the adjuster. In at least one implementation, to achieve functionality, the shower head and the adjuster can be in thermal equilibrium with each other. In at least one implementation, adjuster may also be mechanically coupled with a stabilizer system so that the shower head is substantially parallel to a wafer surface.

At the beginning of a processing operation, temperature may be monitored at one or more locations of the shower head, and the adjuster by temperature sensors. In at least one implementation, substrate support assembly temperature and the chamber temperature may be set to a desired set point. In at least one implementation, shower head and the adjuster temperatures may be adjusted by a combination of heating and cooling. In at least one implementation, heater cartridges may include resistive heating elements that are activated by passage of current, for example. In at least one implementation, heater cartridges may locally heat the materials of the adjuster and the shower head through thermal conduction, for example. Heat may rapidly transport throughout the conductive materials. Fine tuning of temperature may be accomplished by simultaneous passage of cooling fluids through one or more fluid lines. In at least one implementation, one or more fluid lines can perform localized cooling and effect of cooling may rapidly transport throughout the conductive materials. For example, heat from the shower head may transport toward an adjuster that has been cooled, resulting in a reduction of temperature of the shower head. In at least one implementation, the temperature of the shower head may be monitored by one or more temperature sensors in real time. In at least one implementation, an active feedback mechanism may be implemented to control a desired temperature set point for the duration of the process or beyond. In at least one implementation, additional feedback mechanisms may be implemented to proactively account for anticipated temperature changes during the process, such as at an onset of processing or at an end of a process.

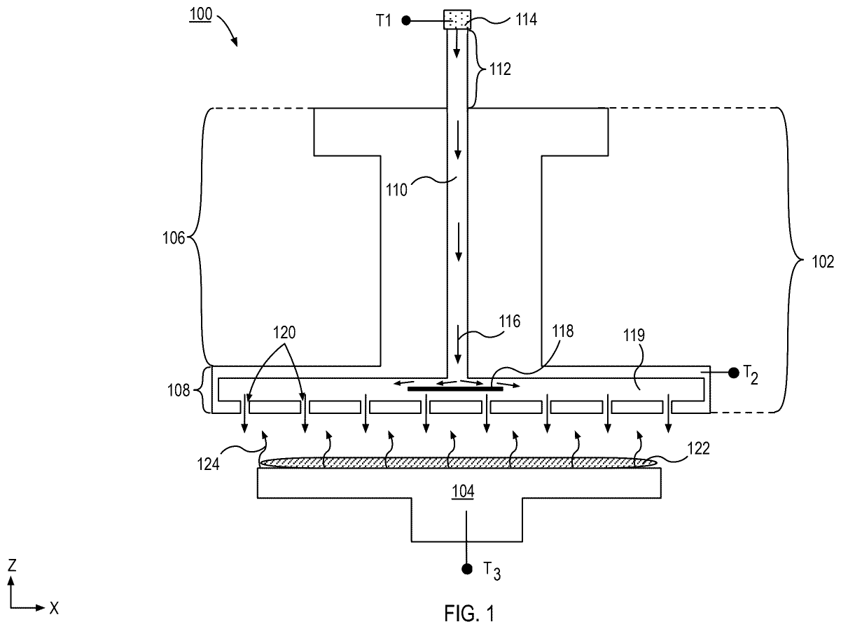

FIG. 1 is a cross-sectional illustration of system 100 that includes shower head 102 and substrate support assembly 104, in accordance with at least one implementation. In at least one implementation, shower head 102 includes a stem 106 and a disk 108 coupled with stem 106. In at least one implementation, shower head 102 includes a cavity 110. Cavity 110 is coupled with a gas delivery tube 112. In at least one implementation, gas delivery tube 112 is coupled with a gas source 114.

Here “disk” may generally refer to a circular shaped object with a cavity within. Here, “shower head” may generally refer to a device that distributes a process gas within a process chamber. In at least one implementation, shower head 102 may generally include a nonconductive material, such as quartz or a conductive material. In at least one implementation, shower head 102 includes a conductive material such as aluminum. Here the term “stem” may generally refer to a columnar structure. In at least one implementation, columnar structure may be a cylinder that is hollow or a solid cylinder with a cavity. The columnar structure may be a tube. Here “cavity” may generally refer to a hollow structure within a solid object. Cavity may be of various shapes and sizes, both regular and irregular. Here “gas delivery tube” may generally refer to a tube that includes a conductive material with a hollow interior. In at least one implementation, tube may be double walled with an insular barrier in between to provide for thermal insulation from a surrounding. Gas delivery tube 112 may be heated. Here, “gas source” may generally refer to a container or a storage facility for one or more process gases. While gas source 114 is shown in close proximity to shower head 102 in the illustration, gas delivery tube 112 is not drawn to scale in the illustration. Here, “substrate support assembly” may generally refer to a plate electrode coupled with a stem. In at least one implementation, substrate support assembly may comprise an electrostatic chuck in which heating and/or cooling elements are included to aid in processing of substrates. In at least one implementation, substrate support assembly may be coupled with a radio frequency power supply.

In at least one implementation, respective temperatures T₁, T₂, and T₃, of shower head 102, substrate support assembly 104, and gas source 114, may be monitored when system 100 is idle or not processing substrates. In at least one implementation, temperatures T₁, T₂, and T₃ may be monitored by temperature sensors coupled with shower head 102, substrate support assembly 104, and gas source 114. In at least one implementation, during operation, gas 116 flows from gas source 114 through gas delivery tube 112 and cavity 110 and strikes distribution plate 118. Here “distribution plate” may generally refer to an opaque structure that provides a barrier for impinging gas molecules. In at least one implementation, during operation, gas 116 striking distribution plate 118 can diffuse within cavity 119 of disk 108 and enters holes 120 in disk 108. Gas 116 flows toward substrate 122 placed on substrate support assembly 104. In at least one implementation, gas may be used to perform etching or deposition. In at least one implementation, substrate support assembly 104 is heated, and temperature T₃ may be substantially greater than temperature T₂. In at least one implementation, gas 116 can be heated at gas source 114 to temperature T₁. In at least one implementation, temperature T₁ is substantially less than temperature T₃. In at least one implementation, temperature T₁ is substantially less than temperature T₃, and temperature T₂ may be substantially equal to room temperature. In at least one implementation, during processing, heat 124 may radiate from substrate 122 and substrate support assembly 104 causing temperature T₂ to fluctuate. In at least one implementation, fluctuations in temperature T₂ can influence the nature of gas 116 travelling through cavity 110. With no active control of temperature T₂ during processing or between processing of subsequent substrates 122, any changes in gas property can adversely influence etching or deposition rates. Thus, temperature control of shower head 102 is highly desirable.

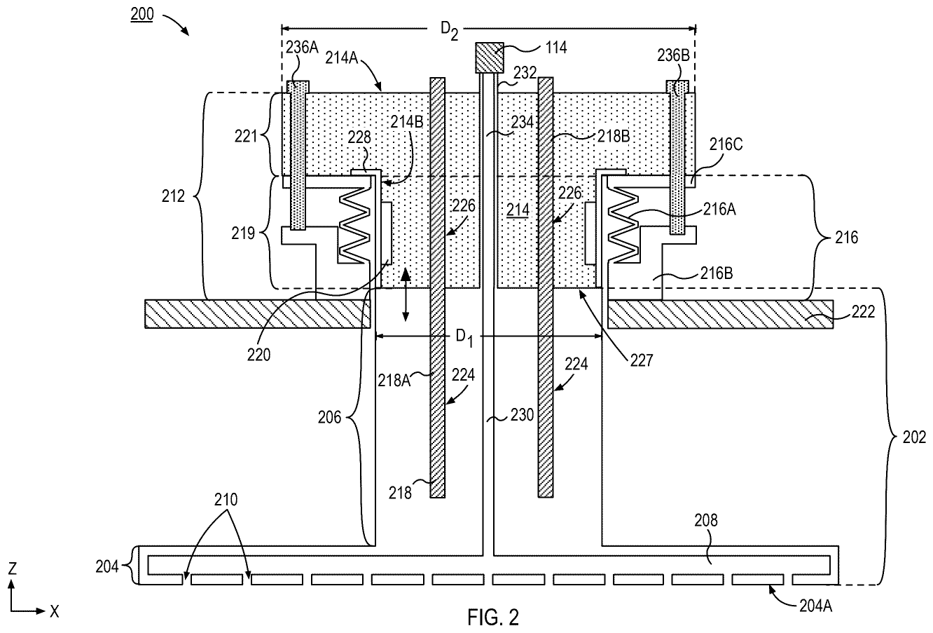

FIG. 2 is a cross-sectional illustration of apparatus 200 that includes shower head 202, comprising disk 204 and stem 206 coupled with disk 204, in accordance with at least one implementation. In at least one implementation, disk 204 may include a hollow cavity 208 and holes 210 for distribution of process gases. In at least one implementation, shower head 202 includes a high thermally conductive material such as aluminum. In one example, thermal conductivity of above 80 watts per meter per Kelvin (W/mK) may be high. In at least one implementation, apparatus 200 further includes adjuster 212 coupled with stem 206. Here, the term “adjuster” may refer to a structure that provides adjustment to a connected structure such as temperature control, or mechanical control such as tilt capability. In at least one implementation, adjuster 212 includes a high thermally conductive material. In at least one implementation, adjuster 212 comprises aluminum. In an implementation, adjuster 212 includes adapter 214, and bellows 216 coupled with the adapter 214. In at least one implementation, adapter 214 further includes heater cartridge 218, and fluid line 220 adjacent to heater cartridge 218.

In at least one implementation, to facilitate routing of heater cartridge 218, fluid line 220 and adapter 214 may include a cylindrical structure. Here, “adapter” may generally refer to a structure that enables two or more objects to be coupled together. In at least one implementation, the adapter may have certain features and structures within. In at least one implementation, adapter 214 includes cylindrical portion 219 and cylindrical portion 221. Cylindrical portions 219 and 221 are contiguous. In at least one implementation, cylindrical portions 219 and 221 have diameters D₁ and D₂, respectively. In at least one implementation, diameters D₁ and D₂ are different. Different diameters D₁ and D₂ of cylindrical portions 219 and 221, respectively, facilitate bellows 216 to be coupled between cylindrical portion 221 and support structure 222. In at least one implementation, support structure 222 is a component of a process chamber that houses apparatus 200. In at least one implementation, adapter 214 further includes holes or cavities for restraining, such as bolts, or for passage of components utilized to effectuate temperature control in shower head 202.

In at least one implementation, apparatus 200 includes three heater cartridges. Here, “heater cartridge” may generally refer to a heating element that releases heat conductively or radiatively to the surrounding area. In at least one implementation, heater cartridges 218A and 218B are visible in the cross-sectional illustration. In at least one implementation, heater cartridge 218A extends from adapter surface 214A through cavity 226 in adapter 214, and within cavity 224 in stem 206. In at least one implementation, surface 214A may be a top surface of adapter 214. Heater cartridges 218A and 218B may be resistively heated by passing current through a filament within the body of the heater cartridges. In at least one implementation, heater cartridges 218A and 218B may be at least 5 mm wide. In at least one implementation, heater cartridges 218A and 218B are between 5 mm-15 mm wide. In at least one implementation, heater cartridges 218A and 218B extend at least 50% of the length of stem 206 as measured from interface 227 between stem 206 and adapter 214. In the illustrative implementation, heater cartridges 218A and 218B extend at least 75% of the length of stem 206.

In at least one implementation, fluid line 220 is advantageously located near interface 227 to provide thermal conductivity to shower head 202 by flowing temperature regulated fluid or coolant. Here, the words fluid and coolant may be, used interchangeably. In at least one implementation, flow of coolant through fluid line 220 can lower the temperature of adapter 214 and shower head 202 which is in thermal contact with adapter 214. In at least one implementation, coolant can be maintained at a range of temperatures, and flow rate of coolant within fluid line 220 can be controlled to regulate heat exchange with adapter 214.

In at least one implementation, fluid line 220 may be a channel within sidewall 214B of cylindrical portion 219 of adapter 214. In at least one implementation, fluid line 220 may extend a partial length of cylindrical portion 219, as shown. In at least one implementation, a channel within sidewall 214B provides at least three surfaces for coolant flowing within fluid line 220 to contact adapter 214. In at least one implementation, fluid line 220 is covered by cap 228 that extends along sidewall 214B. Here, “cap” may generally refer to an object that is utilized to cover an open structure such as a channel. In at least one implementation, cap 228 includes a material that is the same or substantially the same as material of adapter 214. In at least one implementation, cap 228 may be in thermal equilibrium with adapter 214. Here, “fluid line” may generally refer to a structure such as a channel or a body that can support fluid flow. In at least one implementation, fluid line 220 can be a tube that is separate but in thermal contact with adapter 214. In some such implementations, fluid line 220, in the form of a tube, can also encircle stem 206. Further details and implementations of fluid line 220 will be discussed later.

In at least one implementation, shower head 202 further comprises a cavity 230 extending from disk 204 to a top of stem 206. In at least one implementation, stem 206 may be further connected to a hollow cylinder 232 directly above cavity 230. In at least one implementation, hollow cylinder 232 includes cavity 234 that has substantially a same width as a width of cavity 230. Together, cavities 230 and 234 form a tube that is utilized to transport gas or facilitate gas flow from gas source 114 towards holes 210 in disk 204.

In at least one implementation, bellows 216 further includes convolutions 216A between flanges 216B and 216C. Here, “bellows” may generally refer to a device utilized to connect two objects that require structural adjustments (such as tilt). Here, the term “convolutions” may generally refer to a flexible accordion shaped structure that can be expanded and collapsed as well as tilted to within 5 degrees. Here, “flange” may generally refer to a metallic structure that enables coupling with external structures. In at least one implementation, convolutions 216A may include a stainless-steel material and may be welded to flanges 216B and 216C. Flanges 216B and 216C may also include a stainless steel material. The number of convolutions 216A can vary on height HB, of bellows 216.

In at least one implementation, adapter 214 is connected with flange 216C. As shown, cylindrical portion 221 of adapter 214 is on flange 216C. In at least one implementation, flange 216B is supported by support structure 222. Adjuster 212 and shower head 202 may be tilted (relative to the z-axis) by adjusting tilt adjustment screws 236A and 236B relative to flange 216B. In at least one implementation, adjusting tilt adjustment screws 236A and 236B can orient shower head surface 204A to be parallel to a surface of a substrate placed on a substrate support assembly below (not shown). In at least one implementation, shower head surface 204A that is parallel to a substrate is highly desirable because gas that exits through holes 210 distributed throughout shower head 202 may traverse equal distances to substrate 122 below. In at least one implementation, a non-parallel shower head surface 204A can introduce variations in gas trajectories. In at least one implementation, variations in gas trajectories may introduce differences in etch rates or deposition rates across a substrate leading to process non-uniformities.

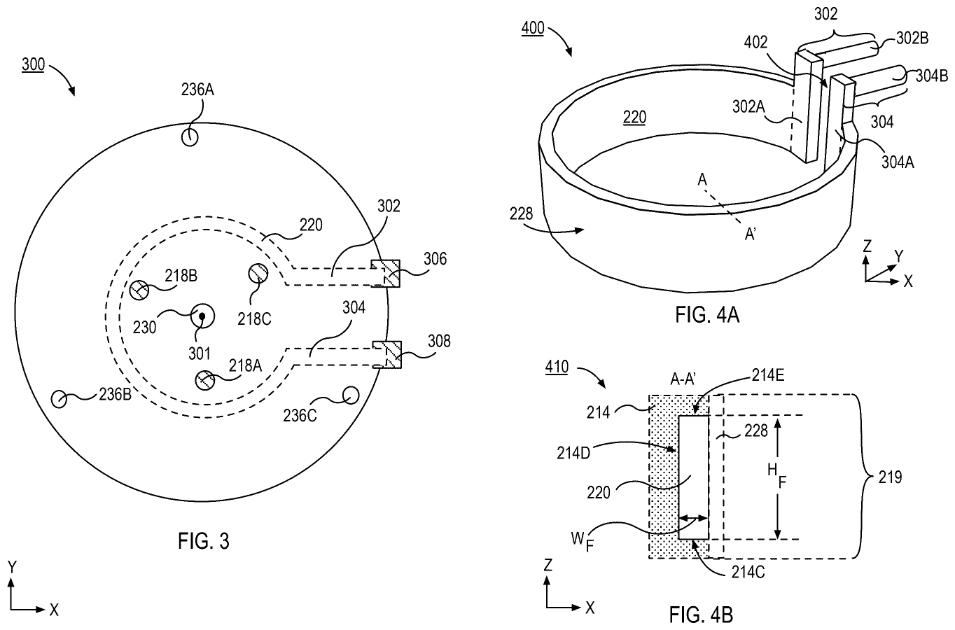

FIG. 3 is a plan view illustration 300 of adapter 214, in accordance with at least one implementation of the present disclosure. In at least one implementation, adapter 214 includes three tilt adjustment screws 236A, 236B and 236C. In at least one implementation, tilt adjustment screws 236A, 236B and 236C are substantially equidistant from each other and from an axial center 301 of adjuster 212. In at least one implementation, as arranged, tilt adjustment screws 236A, 236B and 236C can provide substantial fine tuning of a tilt angle between shower head surface 204A (FIG. 2) and the surface of a substrate support assembly, as described below.

In at least one implementation, three heater cartridges 218A, 218B, and 218C are shown. In at least one implementation, heater cartridges 218A, 218B, and 218C may be distributed uniformly from axial center 301. In at least one implementation, heater cartridges 218A, 218B, and 218C are distributed the same radial distance from axial center 301. In at least one implementation, as arranged, heater cartridges 218A, 218B, and 218C can provide substantial uniformity in heat transport throughout a volume of adjuster 212.

In at least one implementation, fluid line 220 follows a substantially circular path. Line segments 302 and 304 are coupled with fluid line 220 to provide an intake and an outlet, respectively, for a coolant to flow within fluid line 220. Line segments 302 and 304 are further coupled with fittings 306 and 308, respectively, to provide coupling with source and drain lines (not shown). Fittings 306 and 308 may include connectors.

In at least one implementation, heater cartridges 218A, 218B, and 218C are distributed radially between cavity 230 and fluid line 220. Heater cartridges 218A, 218B, and 218C may be at least 5 cm radially away from fluid line 220.

In at least one implementation, during operation, adapter 214 undergoes heat exchange with coolant flowing within fluid line 220. In at least one implementation, heat may be transferred from adapter 214 which may be at a higher temperature, to a coolant maintained at a lower temperature. In at least one implementation, coolant circulating within fluid line 220 can thus transport heat away from adapter 214 as it flows towards an outlet (via fitting 308, for example). Line segments 302 and 304 may not be on the same plane as fluid line 220. For example, line segments 302 and 304 may extend out of the plane of the figure.

FIG. 4A is an isometric illustration 400 of fluid line 220, including line segments 302 and 304, in at least one implementation. In at least one implementation, adapter 214 is not shown in the illustration to provide clarity. In at least one implementation, a portion of cap 228 that covers fluid line 220 is shown to provide context into a volume and shape of fluid line 220. In at least one implementation, fluid line 220 is a partial cylinder with break 402. In at least one implementation, fluid line 220 is coupled with line segments 302 and 304. In at least one implementation, line segments 302 and 304 extend from the fluid line 220 along vertical and horizontal directions. In at least one implementation, line segments 302 and 304 provide a continuous path for fluid to flow into and out of fluid line 220.

In at least one implementation, line segment 302 includes a vertical segment 302A and a lateral segment 302B connected to vertical segment 302A. In at least one implementation, line segment 304 includes a vertical segment 304A and a lateral segment 304B connected to vertical segment 304A. In at least one implementation, vertical segments 302A, and 304A and lateral segments 302B, and 304B may be grooves or channels within cylindrical portion 221 (not shown).

FIG. 4B is a cross-sectional illustration 410 through line A-A′ of the structure in FIG. 4A. Portions of adapter 214 and cap 228 are also illustrated to provide context. In at least one implementation, fluid line 220 has the same structure as illustrated in FIG. 2. In at least one implementation, fluid line 220 enables heat exchange between fluid flowing within fluid line 220 and surfaces 214C, 214D, and 214E. In at least one implementation, fluid volume is partially determined by cross sectional area A_{F}, which is a product of height H_{F}, and width W_{F}, of fluid line 220. In at least one implementation, where fluid line 220 is a channel within cylindrical portion 219 of adapter 214, a maximum height of fluid line 220 is given by a height of cylindrical portion 219. In at least one implementation, a cross-sectional shape of fluid line 220 may be determined by a total heat content to be moderated within adapter 214. In at least one implementation, total heat content to be moderated may depend on the total contact surface area between the fluid and adapter 214. In at least one implementation, total contact surface area may be increased by presence of grooves or protrusions from surface 214D (as will be discussed below). In at least one implementation, for a fixed W_{F}, any protrusions from surface 214D reduces a total volume of fluid that can flow within fluid line 220.

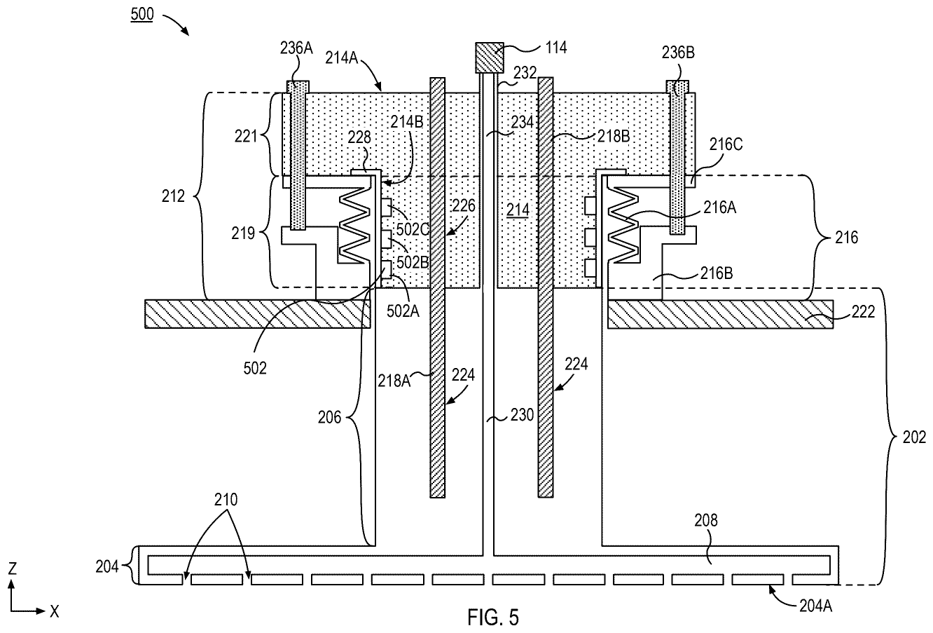

FIG. 5 is a cross-sectional illustration of apparatus 500, in accordance with an implementation of the present disclosure. In at least one implementation, apparatus 500 includes all of the features of apparatus 200 except for fluid line 220. In at least one implementation, apparatus 500 includes fluid line 502 that includes one or more properties of fluid line 220. Fluid line 502 includes grooves or channels. In at least one implementation, fluid line 502 includes three channels 502A, 502B, and 502C. Channels 502A, 502B, and 502C are covered by cap 228 as shown.

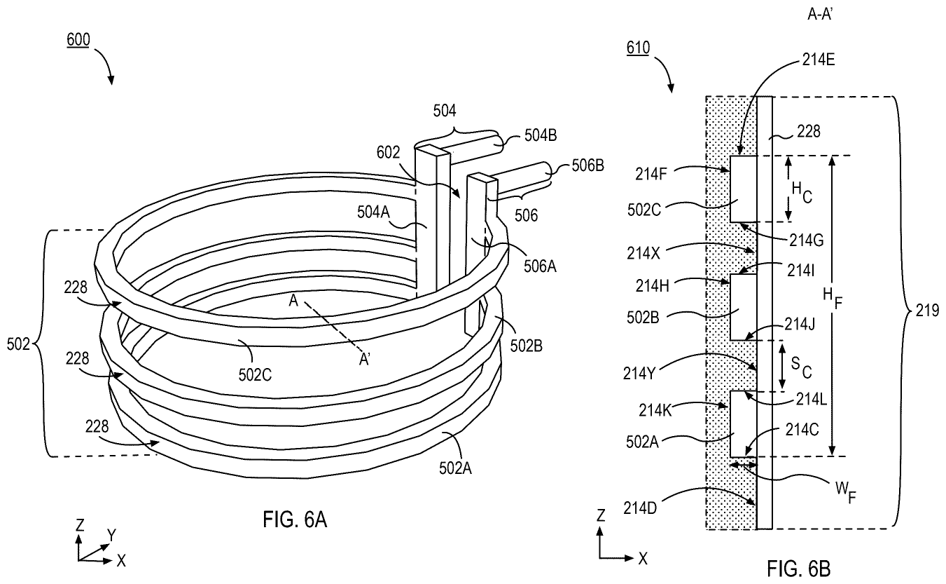

FIG. 6A is an isometric illustration 600 of fluid line 502 including line segments 504 and 506, in accordance with at least one implementation. In at least one implementation, adapter 214 is not shown in the illustration, to provide clarity. In at least one implementation, a portion of cap 228 that covers fluid line 502 is shown to provide context of a volume of fluid line 502. As shown, channels 502A, 502B, and 502C are shaped into cylindrical rings with break 602. In at least one implementation, while individual cylindrical rings are not in contact with each other, individual channels 502A, 502B, and 502C are coupled at a first end with line segment 504 and at a second end with line segment 506. In at least one implementation, line segments 504 and 506 provide a path for fluid to flow into and out of individual channels 502A, 502B, and 502C.

In at least one implementation, line segment 504 includes vertical segment 504A and a lateral segment 504B connected to vertical segment 504A. In at least one implementation, line segment 506 includes vertical segment 506A and lateral segment 506B connected to vertical segment 506A. In at least one implementation, lateral segment 504B may be coupled to a fluid source and lateral segment 506B may be coupled to a fluid drain.

FIG. 6B is a cross-sectional illustration 610 through a line A-A′ of the structure in FIG. 6A. Portions of adapter 214 and cap 228 are also illustrated to provide context. In at least one implementation, fluid line 502 has the same structure as illustrated in FIG. 5. During operation, fluid line 502 enables heat exchange between a fluid flowing within fluid line 502 and various surfaces within adapter 214.

In at least one implementation, fluid volume in fluid line 502 is proportional to cross sectional area A_{N} of individual channels 502A, 502B, and 502C. Cross sectional area A_{N} is a product of height H_{F}, and width W_{F}, of individual channels 502A, 502B and 502C. In at least one implementation, where fluid line 502 is limited to cylindrical portion 219 of adapter 214, a maximum height of individual channels 502A, 502B and 502C is limited by the height of cylindrical portion 219. A cross sectional shape of individual channels 502A, 502B, and 502C may be determined by a total heat content to be moderated within adapter 214. Total heat content to be moderated may depend on a total contact surface area between fluid and adapter 214. In at least one implementation, total contact surface area may be increased by the presence of protrusions within adapter 214.

In at least one implementation, the total contact surface area in fluid line 502 is enhanced compared to a total contact surface area in fluid line 220 (FIGS. 4A and 4B), which has a single partial cylinder. In at least one implementation, fluid that may be transported within channel 502A is in contact with surfaces 214E, 214F, and 214G. In at least one implementation, fluid that may be transported within channel 502B is in contact with surfaces 214H, 2141, and 214J. In at least one implementation, fluid that may be transported within channel 502C is in contact with surfaces 214C, 214K and 214L. In at least one implementation, surfaces 214X and 214Y do not contribute to surface conduction because there is no contact between fluid and these surfaces.

In at least one implementation, there may be a net reduction in fluid volume in fluid line 502 compared to fluid line 220 (FIG. 4B). In at least one implementation, an increase in total contact surface area in fluid line 502 can increase a total amount of heat exchanged between fluid that is transported within fluid line 502 and adapter 214. It is to be appreciated that spacing S_{C} between successive channels (such as 502A and 502B, or 502B and 502C) relative to height H_{C} of channels 502A, 502B, or 502C can be tuned to control the total contact surface area. In at least one implementation, individual channels 502A, 502B, and 502C have the same or substantially the same height H_{C}. Furthermore, spacing S_{C} between channels (such as 502A and 502B, or 502B and 502C) are the same or substantially the same. However, in other implementations, height H_{C} of individual channels 502A, 502B, and 502C can be different from one another. In at least one implementation, spacing S_{C} between channels 502A and 502B can be different from spacing S_{C} between 502B and 502C.

While three channels 502A, 502B, and 502C have been illustrated in FIGS. 5, 6A and 6B, the number of channels can be greater than three and depends on the vertical thickness of cylindrical portion 219.

In at least one implementation, fluid line 502 may comprise a spiral structure. The spiral structure may be coupled between a first end connector and a second end connector. In at least one implementation, the first end connector and the second end connector may not be on the same plane. In at least one implementation, end connectors may be couplings that are utilized to connect the spiral structure to a coolant source, or a coolant drain. Such a spiral structure may not include vertical line segments. In at least one implementation, a spiral structure comprising tubes may be implemented. The tubes can be placed within channels 502A, 502B, and 502C.

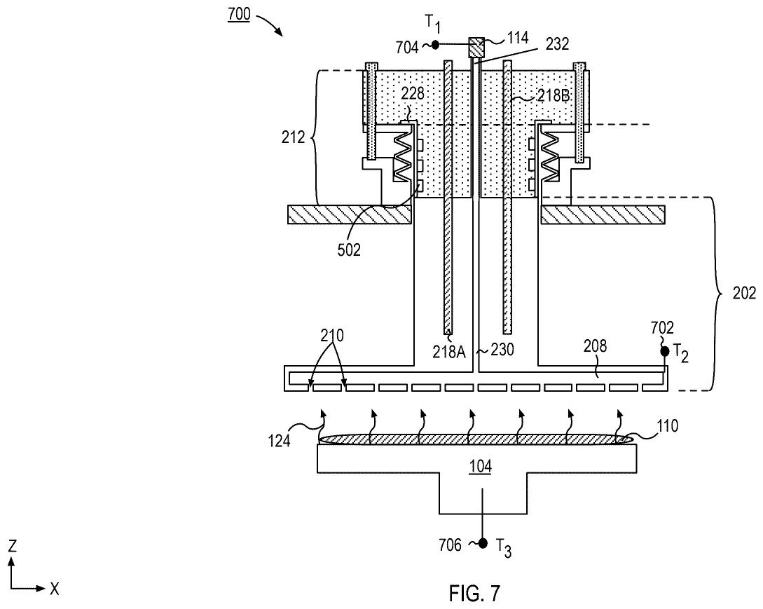

FIG. 7 is a cross-sectional illustration of a system 700 that includes apparatus 500 and a substrate support assembly 104, in accordance with an implementation of the present disclosure. In at least one implementation, system 700 includes temperature sensors 702, 704, and 706. In at least one implementation, temperature sensors 702, 704, and 706 are respectively coupled with shower head 202, gas source 114, and substrate support assembly 104. In at least one implementation, temperature sensors 702, 704, and 706 may be coupled with individual components that are designed to set temperatures of shower head 202, gas source 114, and substrate support assembly 104, respectively. In at least one implementation, such individual components may include temperature controllers. In at least one implementation, temperature sensors 702, 704, and 706 measure respective temperatures T₁, T₂, and T₃ of gas source 114, shower head 202, and substrate support assembly 104, respectively. In at least one implementation, measurements can be made in real time while system 700 is processing substrate 122. In at least one implementation, active feedback from temperature sensors 702, 704, and 706 may be utilized to change temperature at shower head 202.

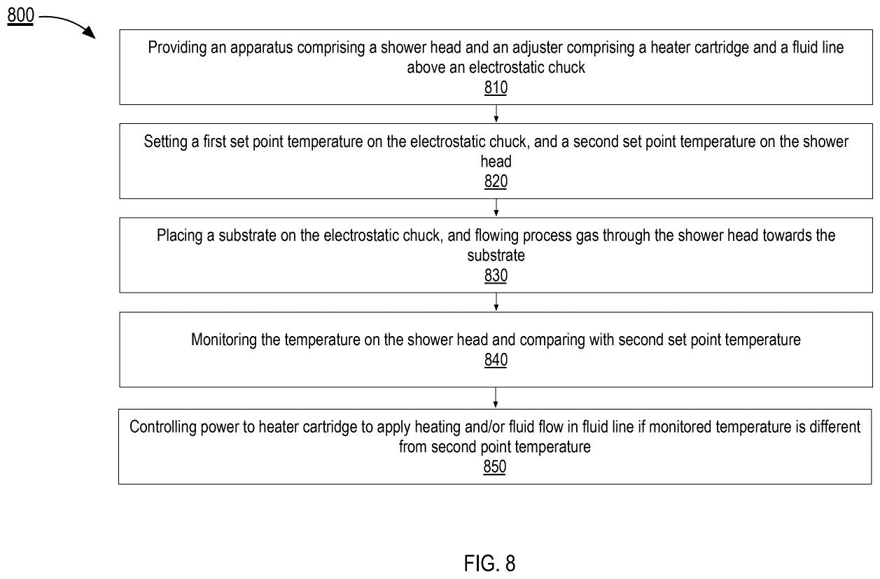

FIG. 8 illustrates a flow diagram of method 800 of operating an apparatus such as apparatus 500 in system 700 (FIG. 7), in accordance with an implementation of the present disclosure. In at least one implementation, method 800 begins at operation 810 by providing a system 700 (FIG. 7). In at least one implementation, method 800 continues at operation 820 by setting a first set point temperature on a substrate support assembly and a second set point on the shower head. In at least one implementation, method 800 continues at operation 830 placing a substrate on the substrate support assembly and flowing process gas through the shower head towards the substrate to process the substrate. In at least one implementation, method 800 continues at operation 840 by monitoring the temperature on the shower head and comparing the monitored temperature with the second set point temperature. In at least one implementation, method 800 concludes at operation 850 by controlling the temperature on the shower head by controlling power to heater cartridges and/or controlling fluid flowing in fluid lines, if the monitored temperature is different from the second set point temperature.

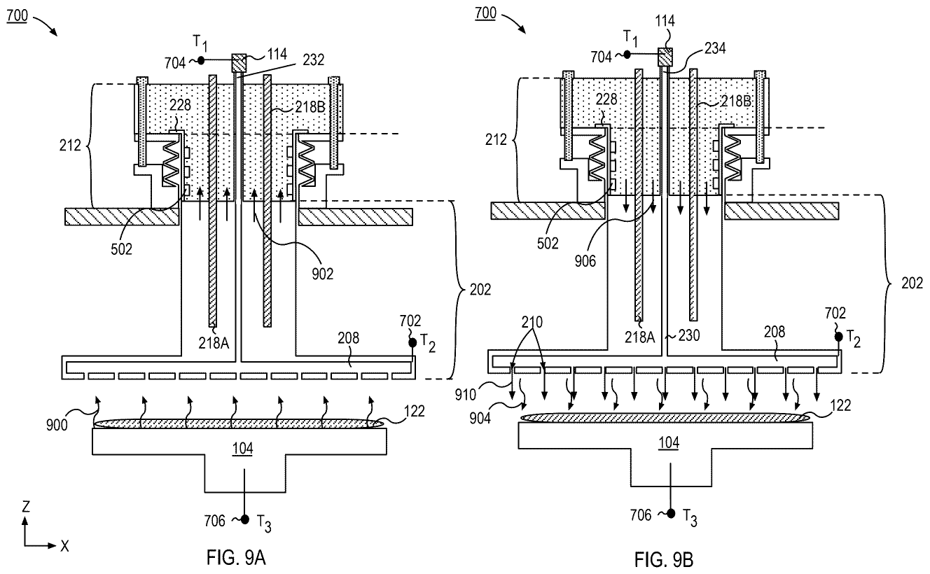

FIG. 9A is a cross-sectional illustration of system 700 that includes apparatus 500 and a substrate support assembly 104, during processing of substrate 122, in accordance with an implementation of the present disclosure. As discussed with regards to FIG. 7, measurements can be made in real time while system 700 is processing substrate 122. In at least one implementation, active feedback from temperature sensors 702, 704, and 706 may be utilized to change temperature at shower head 202. In at least one implementation, temperature T₂ at shower head 202 may be changed by applying power to heater cartridges 218A and 218B and/or by flowing fluid in fluid line 502. In at least one implementation, set point temperature on shower head 202 may be lower than set point temperature on substrate support assembly 104. In at least one implementation, initial temperature T₂ is less than initial temperature T₁.

In at least one implementation, temperature T₂ may increase as processing begins. In at least one implementation, temperature T₂ may increase because heat (denoted by arrows 900) from substrate support assembly 104 may radiate towards shower head 202 and raise temperature T₂. Since shower head 202 is in thermal contact with adjuster 212, temperature changes in shower head 202 can be compensated by cooling within adjuster 212. Heat may be transported (denoted by arrow 902) from shower head 202 to adjuster 212. In at least one implementation, to draw heat from shower head 202, fluid flow can be increased in fluid line 502 to rapidly exchange heat away from the body of adjuster 212. In at least one implementation, if power was applied originally to heater cartridges 218A and 218B, then the applied power can be lowered to reduce temperature within adjuster 212 and shower head 202. In at least one implementation, system 700 includes two pathways for controlling an increase temperature in shower head 202 while processing substrate 122.

FIG. 9B is a cross-sectional illustration of system 700 during processing of substrate 122 in accordance with an implementation of the present disclosure. In at least one implementation, set point temperature on substrate support assembly 104 may be lower than set point on shower head 202. For example, initial temperature T₂ is greater than initial temperature T₁. In at least one implementation, a cold (such as temperature below 70 degrees Celsius) substrate support assembly 104 may be desirable for certain processing conditions. In at least one implementation, shower head 202 may be heated to temperature T₂ that is substantially the same as temperature T₁, where temperature T₁ is the temperature of gas at gas source 114. In at least one implementation, temperature T₁ of process gas may be heated to a process temperature prior to flowing (denoted by arrows 910) through cavities 234, 230 and out of holes 210.

In at least one implementation, temperature T₂ may decrease as processing begins. In at least one implementation, temperature T₂ may decrease because heat (denoted by arrows 904) may radiate from shower head 202 towards substrate support assembly 104 lowering temperature T₂. In at least one implementation, applied power may be increased to heater cartridges 218A and 218B to raise temperature in shower head 202. Since heater cartridges 218A and 218B extend in both the adjuster 212 and in shower head 202 there are two pathways to heating shower head 202. A portion of the heat may be generated within shower head 202 and another portion of the heat may be generated within adjuster 212. The heat generated from adjuster 212 can be transported to shower head 202 (denoted by arrows 906). In at least one implementation, if fluid was flowing within fluid line 502, flow rate of the fluid could be decreased to preserve temperature T₂. In at least one implementation, reduction in rate of fluid flow may reduce an amount of heat exiting adapter 214. In at least one implementation, heater cartridges 218A and 218B and fluid line 502 may be utilized while processing to actively control temperature at shower head 202.

Example 1: An apparatus comprising a shower head comprising a disk and a stem coupled with the disk; and an adjuster coupled with the stem, the adjuster comprising: an adapter, comprising: a heater cartridge; and a fluid line adjacent to the heater cartridge, wherein in the heater cartridge extends from a top surface of the adapter through a first cavity in the adapter and within a second cavity in the stem; and a bellows comprising a flange, wherein the bellows is coupled with the adapter through the flange.

Example 2: The apparatus of example 1, wherein the shower head comprises a cavity extending from the disk to a top of the stem.

Example 3 is the apparatus of any of the examples, particularly example 2,wherein the shower head further comprises a hollow cylinder connected with the stem above the cavity.

Example 4 is the apparatus of any of the examples, particularly example 2, wherein the cavity is cylindrical.

Example 5 is the apparatus of any of the examples, particularly example 1, wherein the heater cartridge extends at least 50% of a length of the stem.

Example 6 is the apparatus of any of the examples, particularly example 1, wherein the adjuster further comprises a first cylindrical portion and a second cylindrical portion above the first cylindrical portion, wherein the first cylindrical portion is on the stem and the second cylindrical portion is coupled with the flange.

Example 7 is the apparatus of any of the examples, particularly example 6, wherein the fluid line comprises a channel in the adapter at a sidewall of the first cylindrical portion.

Example 8 is the apparatus of any of the examples, particularly example 7, wherein the fluid line comprises a spiral structure.

Example 9 is the apparatus of any of the examples, particularly example 7, wherein the fluid line comprises a first channel above a second channel, wherein the first channel and the second channel are connected at a first respective end by a first connector and wherein the first channel and the second channel are connected at a second respective end by a second connector.

Example 10 is the apparatus of any of the examples, particularly example 2, wherein the cavity extends along an axial center of the stem and the disk.

Example 11 is the apparatus of any of the examples, particularly example 10, wherein the heater cartridge is radially between the cavity and the fluid line.

Example 12 is the apparatus of any of the examples, particularly example 11, wherein the heater cartridge is at least 5 mm radially away from the fluid line.

Example 13 is the apparatus of any of the examples, particularly example 1, wherein the adjuster comprises three heater cartridges.

Example 14 is the apparatus of any of the examples, particularly example 1, wherein the adjuster further comprises tilt adjustment screws coupled with the flange.

Example 15: A method of controlling temperature at a shower head in a processing tool, the method comprising: providing an apparatus, comprising: a substrate support assembly; the shower head comprising a disk and a stem coupled with the disk; and an adjuster coupled with the stem, the adjuster comprising: an adapter, comprising: a heater cartridge; and a fluid line adjacent to the heater cartridge, wherein in the heater cartridge extends from a top surface of the adapter through a first cavity in the adapter and within a second cavity in the stem; and a bellows comprising a flange, wherein the bellows is coupled with the adapter through the flange; setting a first set point temperature on the substrate support assembly; setting a second set point temperature on the shower head by controlling power to heater cartridges and/or flowing fluid through fluid lines; placing a substrate on the substrate support assembly; perform processing by flowing process gas through the first cavity and the second cavity and the shower head towards the substrate; monitoring a temperature on the shower head; and controlling the temperature on the shower head by controlling power to the heater cartridge and/or controlling fluid flowing in fluid lines.

Example 16 is the method of any of the examples, particularly example 15, wherein the process gas is heated to a processing temperature prior to flowing through the first cavity and through the second cavity.

Example 17 is the method of any of the examples, particularly example 16, wherein the first set point temperature is greater than the second set point temperature.

Example 18: The method of example 16, wherein the first set point temperature is less than the second set point temperature.

Example 19 is the method of any of the examples, particularly example 17, wherein the processing increases the second set point temperature, and wherein controlling the temperature on the shower head comprises reducing power to the heater cartridge and increasing flow through the fluid line.

Example 20 is the method of any of the examples, particularly example 18, wherein the processing decreases the second set point temperature, and wherein controlling the temperature on the shower head comprises increasing power to the heater cartridge and reducing flow through the fluid line.

Besides what is described herein, various modifications may be made to the disclosed implementations and implementations thereof without departing from their scope. Therefore, illustrations of implementations herein should be construed as examples only, and not restrictive to the scope of the present disclosure. The scope of the invention should be measured solely by reference to the claims that follow.

What is claimed is:

1. An apparatus comprising:
a shower head comprising a disk and a stem coupled with the disk; and
an adjuster coupled with the stem, the adjuster comprising:
an adapter, comprising:
a heater cartridge; and
a fluid line adjacent to the heater cartridge, wherein in the heater cartridge extends from a top surface of the adapter through a first cavity in the adapter and within a second cavity in the stem; and
a bellows comprising a flange, wherein the bellows is coupled with the adapter through the flange.

2. The apparatus of claim 1, wherein the shower head comprises a cavity extending from the disk to a top of the stem.

3. The apparatus of claim 2, wherein the shower head further comprises a hollow cylinder connected with the stem above the cavity.

4. The apparatus of claim 2, wherein the cavity is cylindrical.

5. The apparatus of claim 1, wherein the heater cartridge extends at least 50% of a length of the stem.

6. The apparatus of claim 1, wherein the adjuster further comprises a first cylindrical portion and a second cylindrical portion above the first cylindrical portion, wherein the first cylindrical portion is on the stem and the second cylindrical portion is coupled with the flange.

7. The apparatus of claim 6, wherein the fluid line comprises a channel in the adapter at a sidewall of the first cylindrical portion.

8. The apparatus of claim 7, wherein the fluid line comprises a spiral structure.

9. The apparatus of claim 7, wherein the fluid line comprises a first channel above a second channel, wherein the first channel and the second channel are connected at a first respective end by a first connector and wherein the first channel and the second channel are connected at a second respective end by a second connector.

10. The apparatus of claim 2, wherein the cavity extends along an axial center of the stem and the disk.

11. The apparatus of claim 10, wherein the heater cartridge is radially between the cavity and the fluid line.

12. The apparatus of claim 11, wherein the heater cartridge is at least 5 mm radially away from the fluid line.

13. The apparatus of claim 1, wherein the adjuster comprises three heater cartridges.

14. The apparatus of claim 1, wherein the adjuster further comprises tilt adjustment screws coupled with the flange.

15. A method of controlling temperature at a shower head in a processing tool, the method comprising:
providing an apparatus, comprising:
a substrate support assembly;
the shower head comprising a disk and a stem coupled with the disk; and
an adjuster coupled with the stem, the adjuster comprising:
an adapter, comprising:
a heater cartridge; and
a fluid line adjacent to the heater cartridge, wherein in the heater cartridge extends from a top surface of the adapter through a first cavity in the adapter and within a second cavity in the stem; and
a bellows comprising a flange, wherein the bellows is coupled with the adapter through the flange;
setting a first set point temperature on the substrate support assembly;
setting a second set point temperature on the shower head by controlling power to heater cartridges and/or flowing fluid through fluid lines;
placing a substrate on the substrate support assembly;
perform processing by flowing process gas through the first cavity and the second cavity and the shower head towards the substrate;
monitoring a temperature on the shower head; and
controlling the temperature on the shower head by controlling power to the heater cartridge and/or controlling fluid flowing in fluid lines.

16. The method of claim 15, wherein the process gas is heated to a processing temperature prior to flowing through the first cavity and through the second cavity.

17. The method of claim 16, wherein the first set point temperature is greater than the second set point temperature.

18. The method of claim 16, wherein the first set point temperature is less than the second set point temperature.

19. The method of claim 17, wherein the processing increases the second set point temperature, and wherein controlling the temperature on the shower head comprises reducing power to the heater cartridge and increasing flow through the fluid line.

20. The method of claim 18, wherein the processing decreases the second set point temperature, and wherein controlling the temperature on the shower head comprises increasing power to the heater cartridge and reducing flow through the fluid line.
